(19) United States
(12) Patent Application Publication
(10) Pub. No.: US 2011/0257986 A1
(43) Pub. Date: Oct. 20, 2011

(54) Method for Producing a Property Valuation Report

(76) Inventors: James Edward Deanne, Brier, WA (US); Gregory Walter Joseph Hauth, Mukilteo, WA (US); Shawn Peter Sheridan, Lake Stevens, WA (US)

(21) Appl. No.: 13/083,602

(22) Filed: Apr. 11, 2011

Related U.S. Application Data
(60) Provisional application No. 61/323,356, filed on Apr. 13, 2010.

(51) Int. Cl. G06Q 50/00; G06Q 10/00

(52) U.S. Cl. 705/1.1

(57) ABSTRACT

A method for producing a Property Valuation Report using the combination of an Internet Graphical User Interface (GUI) to query a computer database of property values, a computer database of tax appeal and other applicable forms, and a report generator producing a variety of Property Valuation Reports that are time-shifted to a specific calendar dates in the past, present or future.

### CROSS REFERENCE TO RELATED APPLICATIONS

This patent application is based on provisional application #61/323,356 filed 13 Apr. 2010 titled “Means for Producing a Tax Appeal Package” and claims the filing date of 13 Apr. 2010.

### BACKGROUND

Municipalities around the country depend upon real estate property taxes (also known as “ad valorem” taxes) as a primary source of revenue. These taxes are typically calculated as a percentage of a property's value, whereby the percentage (or millage rate) is determined by the taxing authority and the property's value is determined by a periodic assessment. Multiplying the millage rate by the assessed value provides an annual tax liability charged to the property owner. Most jurisdictions use a millage rate expressed in terms of tax dollars per $1000 of assessed value whereby 1 mill=$1 of property tax for every $1000 of assessed value, which also equates to 1/10 of a cent, or $0.001. In a simple example, a property with an assessed value of $500,000 would have a millage of 500 ($500,000/$1000). Assuming the taxing authority has assessed a millage rate of 10 against this property, the annual property tax owed would be 10×500=$5000.00. Millage rates vary among taxing jurisdictions and vary within each taxing jurisdiction because they are set (and changed) annually.

The “Assessed Value” refers to the value of a real property as determined by a tax assessor or other representative of a taxing authority. The “Market Value” refers to the value of a real property as determined by an independent “Third Party Appraisal” (TPA), by an accepted “Alternate Valuation Method” (AVM) (described further below), a combination of TPA and AVM, or by the sale of a property in an “arm's length” transaction between disinterested buyers and sellers. “Property” refers to a real property such as a single-family residence, town-home, condominium, duplex, tri-plex, four-plex, or other residential properties. Note that this embodiment is not limited to residential properties and can include commercial real estate properties such as strip malls, apartment buildings, or office buildings. “Window” refers to a specific period of time during which a property owner may appeal their property tax. In many jurisdictions, this window opens when the property owner receives a “Notice of Valuation” or similar notice from the taxing authority. The window or deadline to file an appeal closes at some point thereafter as set forth by the taxing authority. Such time period for filing can vary widely according to jurisdiction, from as little as two weeks to over six months. “Property Valuation” refers to a Third Party Appraisal (TPA) or an Alternate Valuation Methodology (AVM) ascertaining the market value of a subject property and comparable market values of similar properties. “Property Valuation Report” refers to the output produced by the methods of the first and second embodiments of the invention described herein.

An “AVM” as used herein refers to a computerized modeling system designed to simulate the physical “walk-through”, or Third Party Appraisal process, providing residential property valuations at a specific point in time by analyzing the sale prices of comparable properties and real estate market conditions.

AVM methodologies are mathematical models based upon numerous factors. Two typical AVM methodologies include the Hedonic and Repeat-Sales methods. The Hedonic Method of property valuation recognizes that housing is a composite good and defines a property's value as a mathematical function of its characteristics and its geographic location. Hedonic methods can be applied to estimate the value of new or existing homes, and observations on value may be actual sales prices, listing prices, appraisal values, or even owners' estimates of housing values. The Repeat-Sales Method uses the observed sales prices of the same properties at different points in time to create a sample of price differentials that can be used to estimate the appreciation/depreciation rates of houses. Neither AVM methodology depends upon the physical inspection of the subject property, as is the case for a Third Party Appraisal or its derivatives—Broker's Price Opinion (BPO), BPO enhanced AVM, Desktop Appraisal with Inspection, Short Form Appraisal Report (2055), Uniform Residential Appraisal Report (URAR).

This invention uses AVM and Third Party Appraisal (TPA) methodologies in combination with generally accepted heuristics to provide time-shifted market valuations for specific properties of interest. “Time shifted” refers to determining a specific value “as of” a specific calendar date of interest for an AVM. A query for an AVM or TPA at some point in the past, present or future will use the heuristics described above to produce a market value based on comparable property values and sales that occurred as close to, but not after, the specified date as possible.

Two variables determine the final tax owed by a property owner. The first is the millage rate, which the owner cannot control because that is determined by the taxing authority. The second variable is the assessed value of the property. A property's assessed value should closely follow the property's true market value. However, many parts of the country have seen a significant difference between a property's true market value and the assessed value. Indeed, the Case-Shiller index of national property values (a widely used index) has shown about a 17% decline Year-over-Year from June 2008 through May 2009.

Although the market value of properties has decreased substantially recently, the assessed values have not. In fact, because of a long lag-time to reassess properties, assessed values may remain unchanged and therefore remain inflated for some time, possibly years. When the market value has decreased substantially below a property's assessed value, a property owner is essentially over-paying property tax. To reduce this tax, property owners can wait for the municipality to reassess the property, but this can take time (often years), and may result in an increase, not a decrease, in taxes owed.

Another option for a property owner is to sell the property. But this latter strategy may cost the property owner much more because of transaction costs, possibly lost equity, replacement costs, moving costs and other tangible and intangible costs to selling. Alternatively, property owners may also appeal their property tax. A tax appeal offers property owners one of the few methods by which they can document a lower property value and therefore lower the taxes owed. For the property owner who wants to remain in their property and lower their costs of ownership by decreasing their tax burden, a property tax appeal is their best option.

Property tax appeals require independent, objective proof that the property value has declined. Property owners need an objective means to determine the fair value of their property and compare that to the assessed value. By doing so, property owners can determine whether they should pursue an appeal to lower their property tax.

Assuming property owners determine that a tax appeal is warranted, the property owner (or alternatively, the “user” as used herein) often needs guidance to create the property valuation report. Taxing authorities typically require the user to complete a set of forms to document the property, the user, and the appeal. The user must sign and submit forms as part of the process to initiate a tax appeal. In addition, the user must provide proof to substantiate the lower property value and therefore, the lower property tax requested by the user. The user must locate the proper forms, complete them, provide third party objective data of comparable home sales in their community to support their appeal, and then submit the entire appeal within a pre-determined window of time as determined by the municipality. These steps are difficult, time consuming, and confusing. Further, because tax appeal rules and forms can vary on a state-by-state, county-by-county, or even on a local township basis, the process for filing is not standardized. As a result, in many cases these requirements only discourage many users from filing an appeal.

What is needed is a method to mitigate the time, cost, and confusion of filing property tax appeals. The approach should be as standardized as possible to create uniformity within tax jurisdictions and scalability for the provider. The approach should provide objective market value data that cannot be manipulated by the user. The market value data must also be specific to a point in time (calendar date) to match up to the date of the assessed value as is required by most tax authorities.

The invention's second embodiment solves a problem relating to discovering past, present and future valuations of specific properties. This feature allows a user to obtain a market valuation of a property at a specified date for purposes other than comparing a property's market value to assessed value. This embodiment uses a web-based interface to receive property address and specific date requests to a database, whereby said embodiment produces a time-shifted AVM or Third Party Appraisal (TPA) for past, present, or future property valuations. For example, said second embodiment makes the calculator available to determine a market value “as of” a date of death of a property owner. This could be used to establish a value in the past for estate tax determinations. Alternatively, if a property owner gifted property to a charity, trust, foundation, spouse, or children without first determining the property's value as of the date of the gift, then said second embodiment allows the user to determine retrospectively the property's value as of the date of the gift. In another example, the property owner might need to determine the value of a personal residence six months in the past to determine the property's value just prior to a catastrophic loss of the home, such as from a fire or hurricane, to make a valid insurance claim. In another example, an investor bidding on a foreclosed property at an auction might be interested in the future value of said property before the investor places a bid. Other examples not described herein are nevertheless anticipated by this embodiment.

### BRIEF SUMMARY OF THE INVENTION

The invention presents two embodiments, both of which provide a web-based user interface with address and specific date requests to a database to produce a time-shifted Alternative Valuation Method (AV) or Third Party Appraisal (TPA) for past, present, and future property valuations.

A method to mitigate the time, cost, and confusion of filing property tax appeals is needed. The approach should be as standardized as possible to create uniformity within tax jurisdictions and scalability for the provider. The approach should provide objective market value data that cannot be manipulated by the user. The market value data must also be specific to a point in time (calendar date) to match up to the date of the assessed value as is required by most tax authorities. The invention's first embodiment provides a means for comparing a property's market value with its assessed value wherein said values must both be adjusted and compared “as of” a specific date set forth by the taxing authority where said property is located.

The invention's second embodiment solves a problem relating to discovering past, present and future valuations of specific properties. For example, a property owner might need to determine the value of a personal residence six months in the past to determine the property's value just prior to a catastrophic loss of the home, such as from a fire or hurricane, to make a valid insurance claim. The second embodiment modifies the first embodiment by allowing a user to enter a specified date manually. It provides a property's market value as of the specified date and omits assessed value. By allowing such “time shifting” of dates as specified by the user, the invention can call up market values for a specified property of interest from a time-series of market values stored in the property database. This allows the user to specify a point in time most desirable for finding a particular market value, even if such a point in time is several months or years ago (up to the limits of the time-series stored in said property database.) The use of known valuation methodologies also allows a user to request a future date for a property's valuation. The invention improves the overall effectiveness and efficiency of the tax appeals process (in the case of the first embodiment) and improves overall access to time-shifted market valuations (in the case of the second embodiment).

### BRIEF DESCRIPTION OF THE DRAWINGS

FIG. 1 is a flow chart of the method of the first embodiment. If the method determines that assessed value is greater than market value, as of the specified date, the output will produce a Property Valuation Report in the form of an AVM.

FIG. 2 is a flow chart of the method of the first embodiment. If the method determines that assessed value is greater than market value, as of the specified date, the output will produce a Property Valuation Report in the form of an AVM together with tax appeals forms.

FIG. 3 is a flow chart of the method of the first embodiment. If the method determines that assessed value is greater than market value, as of the specified date, the output will produce a Property Valuation Report in the form of an Third Party Appraisal together with tax appeals forms.

FIG. 4 is a flow chart of the method of the second embodiment wherein a user can enter a property address and a specific date of interest in the past, present or future to obtain a Property Valuation Report as of said specified date.

### DETAILED DESCRIPTION OF THE INVENTION

The first embodiment described herein provides an automated approach to first determine whether an appeal is warranted. Secondly, assuming that a determination is made that an appeal is warranted, the first embodiment further provides a means to generate a Property Valuation Report comprising dynamically generated forms required by the municipality (state, county, or township) where the subject property is located. Such forms may be provided alone or in combination with a Property Valuation. The output is a report generated from a series of inputs from the user, the owner, the municipality, and a database describing the subject property that generates the Property Valuation report.

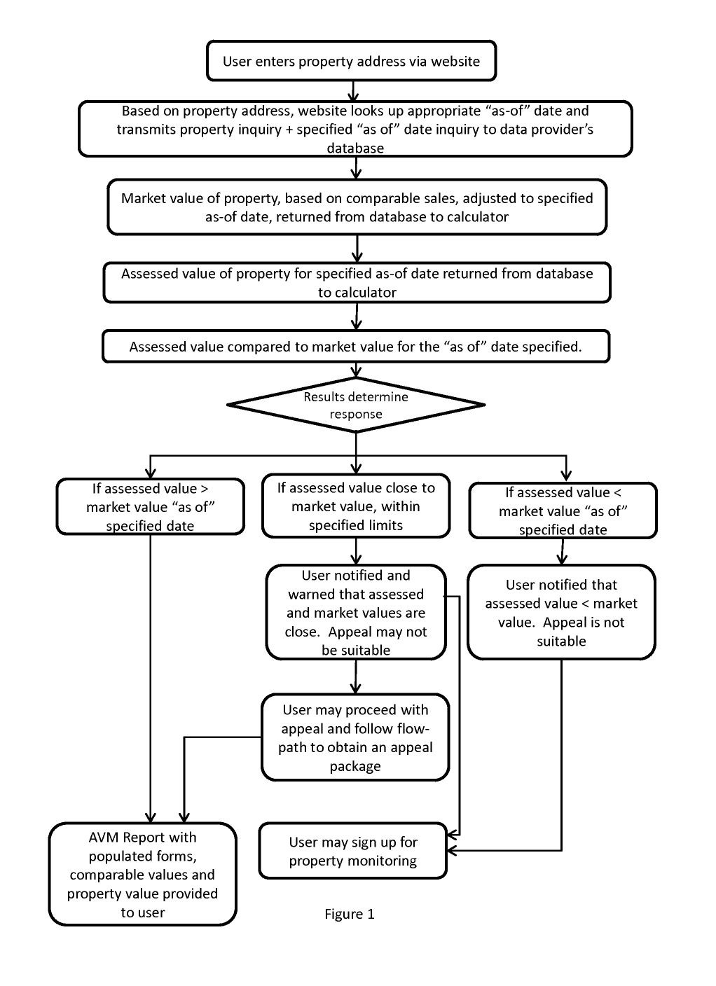

At its basic level, the embodiment comprises the following logical flow path, shown in FIGS. 1, 2 and 3. Initially, a user visits a website (currently www.lowermyassessment.com) to access the first embodiment. The website presents the user with an on-line “calculator.” The user enters a property address as the initial input into the web-based calculator. The address is sent to a database as an inquiry. The property database contains stored comparable sales values for the most recently assessed value of a property and estimated market value as of a specific date. The property database comprises property values of residential and commercial properties from a variety of jurisdictions, either locally (in one state or county), or from multiple jurisdictions around the country. The property database typically aggregates a time-series of comparable sales data and value for each property so that any given property will have multiple valuation combinations based upon the effective date of value requested as well as the date of the query. Each value will be matched with a specific date that such valuation was determined. Because property databases are cumbersome and expensive to create and maintain, it is more cost effective to license access to commercially available property databases through vendor firms such as IntelliReal® or Core Logic®. These vendors then take responsibility for gathering market value and assessed values for properties stored within their property databases. To obtain assessed values, vendors routinely acquire property valuations directly from counties across the country. Therefore, assessed values returned to users from the vendor's database are ultimately derived from the same source—their local tax assessor.

To ensure the most recent assessed valuation for a property is used, the tax appeal calculator used in the first embodiment offers the user an opportunity to override the stored assessment values in the database and enter an assessed value manually, in case they recently received such valuation notice from their local tax authority. This value, if entered by the user, will take precedence over the assessed value returned by the vendor. This capability is important, because the property database may not contain the most recent assessed valuation reported by the tax authority. This feature assumes that a taxpayer may have a more recently assessed value than the property database. The burden is on the user to enter only the most recent and correct assessed value obtained from their tax authority.

Other adjustments to the assessed value may be required depending upon the particular rules of various state, county or other taxing jurisdictions (such as townships or villages.) For example, some states assess properties infrequently, such as once every 10 years, and may be even less frequent. For example, Allegheny County's, (Pennsylvania) most recent assessment of properties was performed in 2002. In order to provide a more recent assessment of properties, these entities use various adjustments to the original (and stale, outdated) assessment. Pennsylvania, for example, considers each tax assessment to be a percentage (or ratio) of the original assessed value to the fair market value of the property. Each county provides the PA State Equalization Board with lists of properties sold and the percentage (ratio) of the original assessment to the sales price. The State Equalization Board then averages all the ratios to create an average percentage to be applied by all PA counties each year. The average percentage is called the Common Level Ratio (CLR). For example, if a property had an assessment of $583,000 in 2008 at the 58.3% CLR for Delaware County, applicable in 2009, then the presumed fair market value is $1,000,000. Assuming the actual fair market value has dropped by 20%, the property should be valued at $800,000. The present embodiment can use the CLR of 58.3% as a factor to adjust the AVM's market value to calculate the assessed value. In this example the assessed value should be $466,400 not $583,000. This property is over assessed by $116,600. Using a millage rate of 20, for example, means the difference is worth 0.020*$116,600=$2332 per year that the property owner is over-assessed. The CLR provides one example where an adjustment to assessed value may be required. Other states use a variety of methods similar to, but calculated and adjusted differently from, the example provided. There is no common standard among states or other property tax jurisdictions. In another example, several states use a Fractional Assessed Value, where the published “assessed value” may be 10% of the full assessed value. If the taxing authority uses a fractional value for the assessment, the embodiment's calculator will adjust the Fractional Assessed Value by applying an applicable multiplier, such as a multiplier of 10 for a county that uses a 10% fractional value. This Corrected Assessed Value (CAV) is used to allow a valid comparison to the Fair Market Value or Full Cash Value (FCV) as appropriate and/or as required by the taxing authority.

The present embodiment provides a means to provide an adjustment factor as described above for assessed values. Some taxing jurisdictions report assessed values on an adjusted basis already, while others do not, so the assessed values reported from each taxing jurisdiction must be checked for accuracy and adjustment. Note that any such adjustments are made only in accordance with the taxing jurisdiction's own rules so that upon review by an appeals board, the appeal should provide valid calculations for any adjusted assessment value.

To obtain market value, vendors such as those mentioned apply acceptable valuation models to derive market valuations for individual properties of interest. The real property's market value may be determined through several AVM methodologies as described earlier.

In the first embodiment, the invention uses a third-party AVM as the basis for determining the estimated value of a subject property for comparison against the assessed value. The preferred embodiment uses four different valuation models and a supervisory algorithm to ensure that the most accurate and relevant estimate of value is delivered for each subject property. All of these valuation models are known in the prior art. In one embodiment, an appraisal based on a physical inspection is used. AVM reports may have some of the same data found in traditional property appraisals such as the URAR or Uniform Residential Appraisal Report, but they are not considered to be an appraisal or to have an appraiser associated with their creation.

In the first embodiment described, shown in FIG. 1, the property database used is a commercially available one, accessible through a license agreement from at least one of the aforementioned vendors. When a user enters their property address on the embodiment's calculator contained in the website, the address is transmitted electronically to the property database together with a specific calendar date inquiry. The invention's first embodiment depends upon a specified calendar date for the property's valuation inquiry that is derived from a look-up table of stored values, whereby the table contains the “as of” date specified by a taxing authority for each jurisdiction offered.

For example, for tax assessments mailed in 2009, Washington State specifies a “tax-roll” of Jan. 1, 2008. Such “point-in-time” comparisons are required by most taxing authorities to qualify for an appeal. Note that the terms “point in time”, “specified date” and “as of date” are used interchangeably herein.

For a user entering an address located anywhere in Washington State, the embodiment would use the property's address to look up the Jan. 1, 2008 date specified by Washington state's tax assessor, and the invention will return assessed values and market values based on the same Jan. 1, 2008 calendar date. The lookup table contains the specific dates set forth by municipal jurisdictions throughout the United States for tax appellants to compare market values with tax assessment values “as of” the date specified by each tax jurisdiction throughout the United States. The lookup table is not limited to the size of the jurisdiction (state or county) or to the number of jurisdictions available.

To further illustrate the problem in a simplified manner, assume that a homeowner obtains an appraisal on Jun. 20, 2009 for a King County, Wash. property so they can appeal an assessed valuation, whereby such assessed valuation is based on Jan. 1, 2009 assessment date. If the homeowner provided a market value based on their appraisal “as of” Jun. 20, 2009, the appraisal would not be valid for the appeal because the date of the appraisal (Jun. 20, 2009) was not the same date as the assessment value (Jan. 1, 2009). The homeowner would have made a costly error (paying for an appraisal) that would ultimately result in a decline of their appeal and require that they wait until the next filing window to try again.

It is important to note that a user of said embodiment may not manipulate data to obtain a desired result that may unfairly favor the taxpayer and so unfairly disadvantage the taxing authority. The market value returned by the property database may not be manipulated by the user. Further, the assessed value may be changed manually as described earlier herein only to insert a more recent assessed valuation, if the assessed valuation has been obtained from the tax authority. The output report will reflect such dates and valuation inputs so that, if incorrect, such errors will be seen by both the user and the Board of Appeals.

Once the user completes the inputs, the address is sent to the property database. In the first embodiment, a property database maintained by a vendor then looks up the stored values for the property address and returns both a market value and an assessed value for that property to the website calculator (FIGS. 1 to 3), for the “as of date” specified by the taxing authority. In addition, any adjustments to the assessed value, as previously described, are made.

The calculator compares assessed value to market value as shown and returns a response to the user indicating whether the market value is greater than, approximately the same as, or less than, the assessed value.

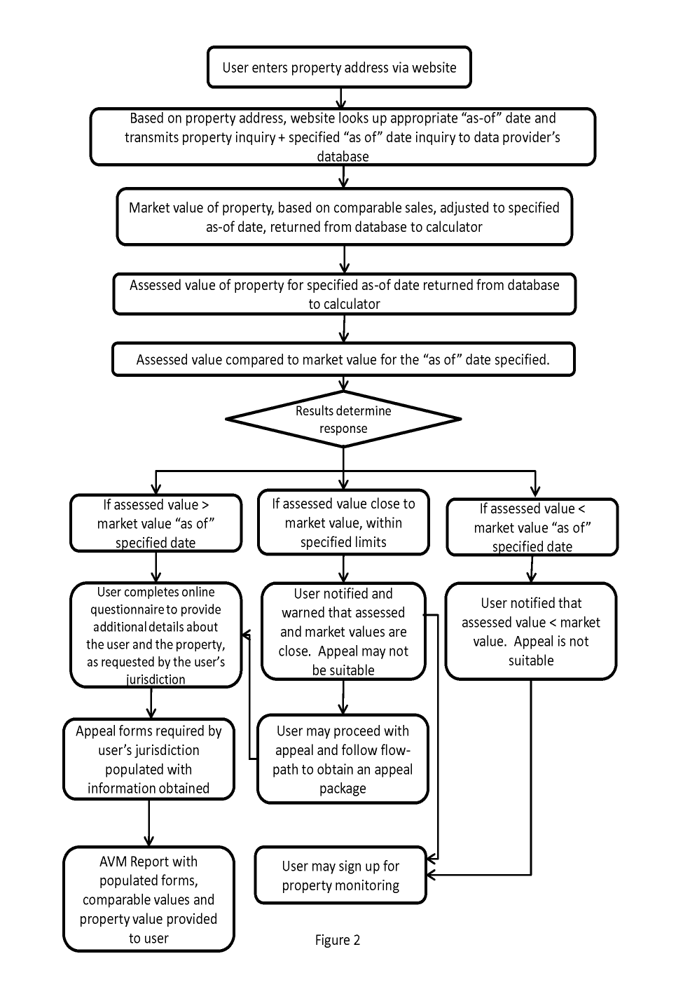

After comparing assessed value to market value, the first embodiment may display the results to the user in a variety of formats: by showing both assessed and market values, by showing only the difference, by showing metaphorically whether the market value is higher than, the same as, or lower than assessed value, such as by using red, yellow or green stop-lights, or by showing houses of varying sizes. The embodiment may use any combination of written or spoken words, numbers, symbols, or metaphors to convey to the user the market value to assessed value differential. At this point, depending upon the results, a variety of options are possible. FIG. 2 describes the flow path based on output from the calculator.

For properties whose market value is greater than assessed value as shown in FIG. 2, the appeals process is terminated because an attempt to appeal a property with a higher market value than assessed value could result detrimentally in an increased property tax to the user. The user is given a message describing this result. The user is also offered an opportunity to subscribe for ongoing property value monitoring in the event the value of the property falls in the future to a point where a property tax appeal is worth pursuing.

For properties whose market value is approximately the same as the assessed value, as shown in FIG. 2, the user is given the option to proceed or terminate. “Approximately the same as” means a market value within 5% of the assessed value for the preferred embodiment. Users who may have only a marginal gain on a percentage basis (e.g., a 4% advantage of lower market value than assessed value) may opt to proceed with a tax appeal if they have either a high value property or a high millage rate, whereby the projected dollars saved from an appeal makes the attempt worthwhile. This margin is arbitrarily set and may be increased (e.g., to 6%) or decreased (e.g., to 1% or 2%) as needed. The user is given a message describing this result. The user is also offered an opportunity to subscribe for ongoing property value monitoring as shown in the event the value of their property falls in the future to a point where a property tax appeal is worth pursuing.

For properties whose market value is less than assessed value by more than the marginal amount described above as shown, the user is given a message describing this result as a basis to proceed with the process for generating a Property Valuation Report and the process continues.

Following this calculator step, and assuming a user has a favorable result from the calculator to proceed with a property tax appeal, the user may begin the process of creating a Property Valuation Report. Depending upon the location of the property based on the address entered originally in the calculator, the embodiment accesses a second forms database that calls up a form for the subject property's assessor as shown in FIG. 2. The forms database contains forms stored in it derived from the taxing municipalities of each county and state in the United States where the Property Valuation Report is offered. In some cases, the same form is acceptable for an entire state. In other cases, every county in a state may have its own tax appeals form. The taxing authority requires the user to complete these forms, and sign and submit them as part of the process to initiate a tax appeal. Furthermore, the user must provide proof to substantiate the lower property value and therefore, the lower property tax as requested by the user.

In the first embodiment, the zip code for the subject property is used in a look-up table to determine the specific questions and answers requested by that jurisdiction's taxing authority. This embodiment then obtains the answers to the questions through two sources: (1) the user, who enters information through the web site; and (2) from the property database, where information about the subject property may already be known and supplied from public documents (e.g., the square footage of the property.) To avoid duplication of data, the website interview process only asks the user to enter data that is not readily available from the property database.

The user continues with the interview process, answering questions needed to complete the tax appeals process. Following the interview process, the user is asked to pay for the service. Following qualification of payment, the system completes the Property Valuation Report by populating forms with answers obtained by the user and/or with information available from the property database.

The system then retrieves the proper tax forms from the forms database for the property's jurisdiction. Tax forms from municipalities or states, if applicable, from around the country have previously been entered into the forms database. The embodiment couples the forms database with a forms generator, currently provided through a commercial license from Adobe® Systems using Adobe Acrobat Version 9. Upon completion of the process, the embodiment will populate pre-stored forms in the forms database with information provided during the interview to generate a set of tax appeals forms containing most of the information requested to make the appeal. Typically, upon receipt of the substantially completed forms, the user reviews the forms for accuracy, signs them, and mails them to the local Property Tax Board of Appeals or Tax Equalization Board (or such other similarly authorized appeals board.)

The first embodiment produces an AVM report as shown in FIGS. 1 and 2 that describe the assessed value and market value of the subject property. The format, style, and total amount of information contained in AVM reports are not standardized and may vary substantially. The AVM need not meet specific formatting requirements, but should provide sufficient, objective, independent data of comparable home sales and market value comparables to the user's property, so that the user can support their claim for a lower property valuation and pay lower property taxes.

The Property Valuation Report may be provided to the user as a combination of both the appeal forms specific to their jurisdiction with the AVM report as shown in FIG. 2. The report may optionally be delivered through a variety of means such as through postal mail, electronic delivery, facsimile, etc. The report may optionally include an AVM report with tax forms from the appropriate jurisdiction that are not completed by the invention, and instead are left to the user to complete and submit to the taxing authority.

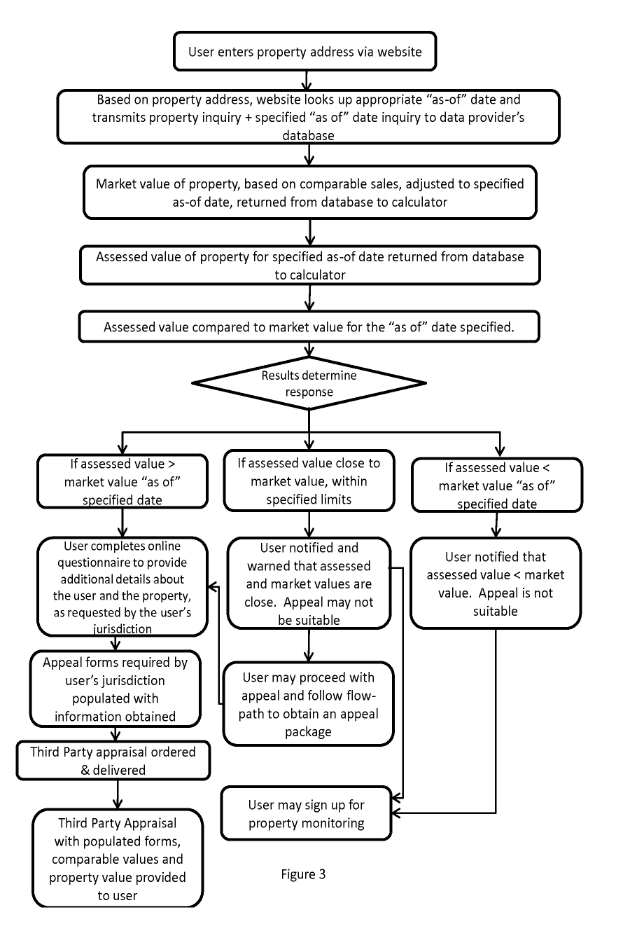

Alternatively, in the first embodiment, a user may request only an AVM report as shown in FIG. 1 without any forms pertinent to filing an appeal. In such a case, the user is responsible for obtaining and correctly completing the tax appeals forms required by their jurisdiction. In some cases, complex properties cannot be accommodated by an AVM and a Third Party Appraisal (full, physical appraisal) is required by a certified appraiser. Such properties include condominiums, customized residences, high-value homes, homes with special circumstances affecting their value (e.g., waterfront views). Users may indicate this and the process will provide them with the proper tax appeals forms, but will not issue an AVM as shown in FIG. 3. Instead, arrangements will be made to obtain a Third Party Appraisal and provide the completed forms with said appraisal to the user.

The second embodiment described herein modifies the first embodiment by allowing a user to enter a specified date manually. By allowing such “time shifting” of dates as specified by the user, the calculator can call up market values for a specified property of interest from a time-series of market values stored in the property database. This allows the user to specify a point in time most desirable for finding a particular market value, even if such a point in time is several months or years ago (up to the limits of the time-series stored in said property database.) In addition, the second embodiment is modified to return only a market value as of a specified date requested by the user, and does not return an assessed value. This feature allows a user to use the calculator for a variety of purposes other than determining market value compared to assessed value, as previously described. The purpose of both embodiments is to maintain a high degree of fairness to both the user, the taxing authority (in the case of the first embodiment), or to an insurance company, the IRS, or others who may depend on the Property Valuation Report (in the case of the second embodiment). The intent is to prevent unfair manipulation of said Property Valuations or other adverse consequences, while at the same time improving the overall effectiveness and efficiency of the tax appeals process (in the case of the first embodiment) and improving overall access to time-shifted market valuations (in the case of the second embodiment).

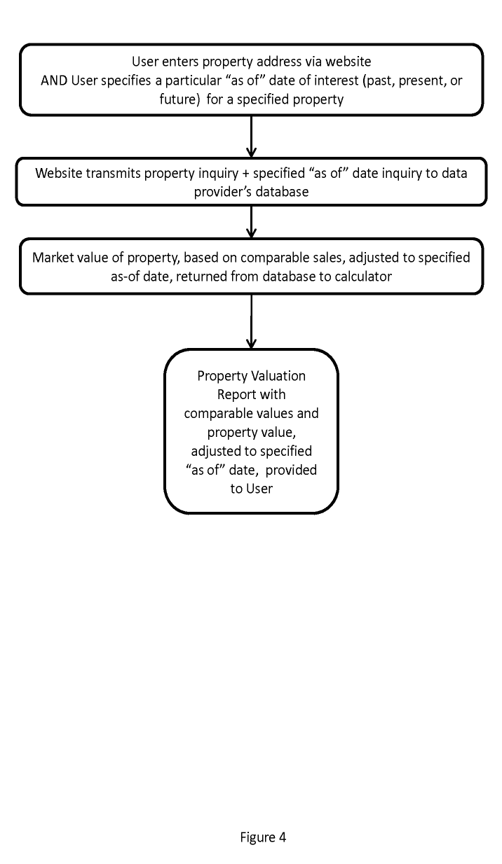

In the second embodiment, shown in FIG. 4, the user may request a time-shifted AVM specific for gifting purposes, insurance, etc. as previously discussed. Users may indicate their desire to obtain and receive only a time-shifted AVM value for their property. The time shifted AVM may be for any date in the past, going back to the limits of stored values in the database. In the preferred embodiment, users may call up stored values going back over ten years. However, this is not a limitation that affects or modifies the invention. Users may also call up values in the present time, or may request values for a property up to one year in the future. Such future values are determined a variety of ways, using heuristics such as trend analysis, Black-Scholes formulas, etc. Such future value methodologies are known in the prior art.

Since said second embodiment requires a user to enter only a property address and a specific date of interest, the input interface can be simple and can be made accessible to a user via a web interface, a smart phone or other wireless device, via voice command over a phone, or through other input devices, such as through a smart television. In all cases, the present embodiment will produce a Property Valuation Report via electronic delivery in an Adobe pdf format.

Said second embodiment's ability to retrieve past, present or future values through a simple interface and easy delivery mechanism are thought to be new, useful and non-obvious.

We claim:

1. A method for operating a general purpose data processor of known type to enable said processor to execute formulas in an object program comprising a plurality of formulas, such that the same results will be produced when given the same data, electronically calculating a tax appeal for real property comprising:
a. A computer processor means for processing data,
b. A computer storage means for storing data on a storage medium,
c. A graphical user interface (GUI) input means whereby said user inputs the address of a real property into said computer,
d. a computer database containing a plurality of assessed values of real properties, stored on said computer, wherein each property has one or more values,
e. a plurality of functions configured to retrieve assessed values and perform operations to adjust assessed values to conform to a date specified by a lookup table, such date conforming to an “as of” date required by the taxing authority wherein said property is located,
f. a computer database containing a plurality of market values of real properties, wherein each property has one or more values adjusted to an “as of” calendar date specified by a taxing authority wherein said property is located,
g. a plurality of query functions configured to retrieve the adjusted assessed value and adjusted market value for a specific property from said databases, for the same specified calendar date,
h. a plurality of calculator functions configured to compare said retrieved values,
i. a plurality of calculator functions configured to provide output comparing said market value to said assessed value and provide an output response to user depending on whether said market value is great than said assessed value, less than said assessed value, or approximately the same as assessed value,
j. for market values less than assessed values, an output function wherein a property valuation report is provided comprising said adjusted market value for the property, “as of” the date specified.

2. The method of claim 1, wherein the output of said calculator functions produces an Alternate Valuation Method (AVM) report for said property, said AVM based on a calendar date matching the “as of” date required by the taxing authority in which said property is located.

3. A Property Valuation Report comprising specific tax appeal forms as required by the taxing authority of said property's jurisdiction provided in blank form and an AVM, produced from the method of claim 1.

4. The method of claim 1 wherein specific tax appeal forms as required by the taxing authority of said property's jurisdiction are populated with information derived from a combination of user inputs and stored information about said property.

5. A Property Valuation Report comprising substantially completed tax appeal forms as required by the taxing authority of said property's jurisdiction and an AVM, produced from the method of claim 4.

6. A Property Valuation Report comprising substantially completed tax appeal forms and a Third Party Appraisal, produced from the method of claim 1.

7. The method of claim 1, wherein the output of said plurality of calculator functions notifies said user that an appeal is not suitable.

8. A method for electronically producing a valuation for real property at various dates in the past, present, or future comprising:
a. A computer processor means for processing data,
b. A computer storage means for storing data on a storage medium,
c. A graphical user interface (GUI), whereby said user enters a specific date of interest for said property valuation,
d. a property database containing market values of real properties, wherein each property has one or more values specific to a point in time available for retrieval,
e. a plurality of query functions that retrieve the market value for a specific property, for a specific calendar date, and returns said market value to said user, and;
f. a plurality of output functions configured to provide output in electronic form.

9. The method of claim 8, wherein said property database values are available for query and retrieval by a remote wireless cellular device to produce an Alternate Valuation Method report.

10. The method of claim 8, wherein said valuation is projected for a future date in time.
